(19) United States
(12) Patent Application Publication
(10) Pub. No.: US 2021/0125296 A1
(43) Pub. Date: Apr. 29, 2021

(54) PATENT SET ANALYSIS SYSTEM

(71) Applicant: Proactive Patents, LLC, Allen, TX (US)

(72) Inventor: Keith William Melkild, Allen, TX (US)

(21) Appl. No.: 17/080,801

(22) Filed: Oct. 26, 2020

Related U.S. Application Data
(60) Provisional application No. 62/925,758, filed on Oct. 24, 2019.

(51) Int. Cl. G06Q 50/18; G06Q 10/10; G06F 16/93; G06F 17/18

(52) U.S. Cl. CPC G06Q 50/184; G06Q 10/10; G06Q 20/1235; G06F 17/18; G06F 16/93

(57) ABSTRACT

An example operation includes one or more of adding a raw score of a main independent claim (IC) of a patent to an IC score data point set, adding the raw patent score to a patent score data point set, calculating summary statistics for the IC score data point set and the patent score data point set, calculating IC data point statistics for the raw score of the main IC and grade of raw IC score based on the summary statistics for the IC score data point set, calculating patent data point statistics for the raw patent score based on the summary statistics for the patent score data point set, calculating a grade of raw patent score based on the patent data point statistics, and displaying the grade of the raw patent score.

### BACKGROUND

Analyzing patents have been performed by the analysis of many different aspects of the patent, for example the title, the abstract, the claims, etc. While these may offer insight to the patent, analysis of the claims of the patent is usually the most insightful aspect of the patent. Herein, any reference to patent may refer to a patent application or an issued patent. Independent Claims are referred to as ICs throughout the document.

### SUMMARY

One example embodiment provides a method that includes one or more of adding a raw score of a main independent claim (IC) of a patent to an IC score data point set, adding the raw patent score to a patent score data point set, calculating summary statistics for the IC score data point set and the patent score data point set, calculating IC data point statistics for the raw score of the main IC and grade of raw IC score based on the summary statistics for the IC score data point set, calculating patent data point statistics for the raw patent score based on the summary statistics for the patent score data point set, calculating a grade of raw patent score based on the patent data point statistics, and displaying the grade of the raw patent score.

Another example embodiment provides a system that includes a memory communicably coupled to a processor, wherein the processor performs one or more of add a raw score of a main independent claim (IC) of a patent to an IC score data point set, add the raw patent score to a patent score data point set, calculate summary statistics for the IC score data point set and the patent score data point set, calculate IC data point statistics for the raw score of the main IC and grade of raw IC score based on the summary statistics for the IC score data point set, calculate patent data point statistics for the raw patent score based on the summary statistics for the patent score data point set, calculate a grade of raw patent score based on the patent data point statistics, and display the grade of the raw patent score.

A further example embodiment provides a non-transitory computer readable medium comprising instructions, that when read by a processor, cause the processor to perform one or more of adding a raw score of a main independent claim (IC) of a patent to an IC score data point set, adding the raw patent score to a patent score data point set, calculating summary statistics for the IC score data point set and the patent score data point set, calculating IC data point statistics for the raw score of the main IC and grade of raw IC score based on the summary statistics for the IC score data point set, calculating patent data point statistics for the raw patent score based on the summary statistics for the patent score data point set, calculating a grade of raw patent score based on the patent data point statistics, and displaying the grade of the raw patent score.

### BRIEF DESCRIPTION OF THE DRAWINGS

FIG. 1 illustrates an example system diagram, according to example embodiments.

FIG. 2A illustrates a code segment of patent set analysis, according to example embodiments.

FIG. 2B illustrates a flowchart of patent set analysis, according to example embodiments.

FIG. 3 illustrates a GUI snapshot of patent set analysis, according to example embodiments.

FIG. 4 illustrates another GUI snapshot of patent set analysis, according to example embodiments.

FIG. 5 illustrates a code segment of finding patent peers, according to example embodiments.

FIG. 6 illustrates a GUI snapshot of finding patent peers, according to example embodiments.

FIG. 7 illustrates a code segment of extended patent set analysis, according to example embodiments.

FIG. 8 illustrates a GUI snapshot of extended patent set analysis, according to example embodiments.

FIG. 9 illustrates a code segment of automated maintenance fee recommendations, according to example embodiments.

FIG. 10 illustrates a GUI snapshot of automated maintenance fee recommendations, according to example embodiments.

FIG. 11 illustrates another GUI snapshot of automated maintenance fee recommendations, according to example embodiments.

FIG. 12 illustrates a code segment of law firm analysis, according to example embodiments.

FIG. 13 illustrates a GUI snapshot of law firm analysis, according to example embodiments.

FIG. 14 illustrates another GUI snapshot of law firm analysis, according to example embodiments.

### DETAILED DESCRIPTION

This document describes a patent analysis system including the logic required to implement various services it might provide.

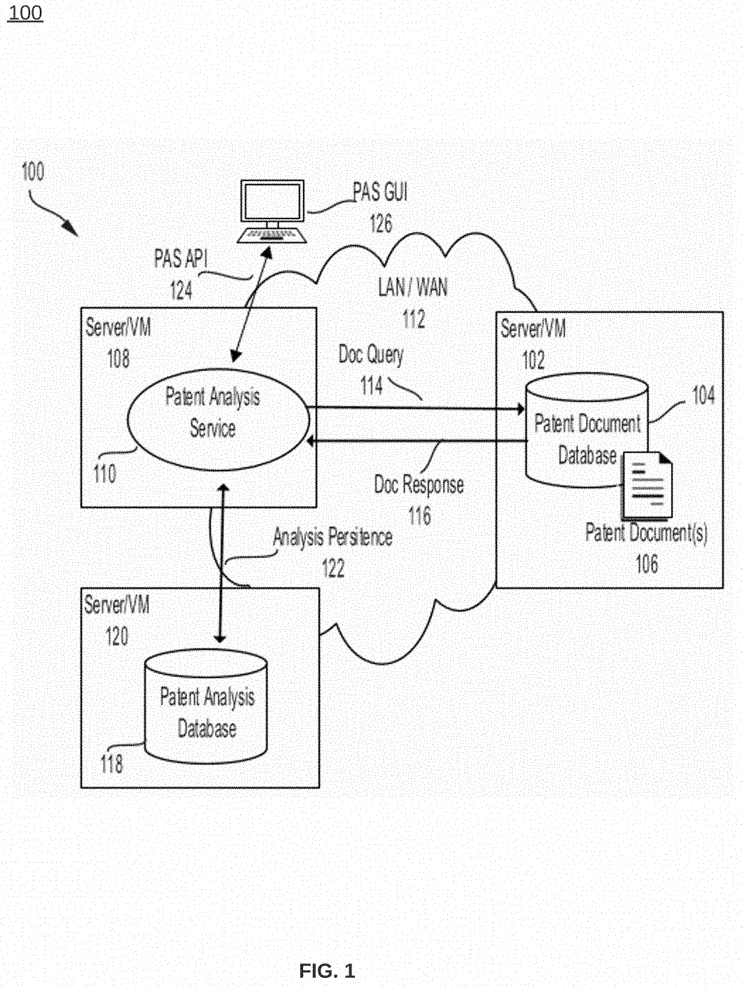

FIG. 1 illustrates an example system diagram, according to example embodiments. A Patent analysis system 100 is depicted in accordance with one or more embodiments of the present disclosure. Please note that any depicted network connection may be wired or wireless. Additionally, any data transmitted can occur via any wired or wireless network/protocol (which may or may not be depicted). Finally, any depicted device may be a computer server or a mobile device.

The Patent Analysis System 100 is comprised of at least one server or virtual machine (VM)/container 102. In one embodiment server 102 hosts a patent document database 104 which contains patent documents 106 from one or more patent and trademark offices. Further, the patent documents 106 can be searched using various attributes of a patent document including, but not limited to publication id, Cooperative Patent Classification (CPC), publication date and keywords.

In one embodiment, a server or virtual machine (VM)/container 108 hosts a patent analysis service 110. The patent analysis service 110 is responsible for analyzing a set of patents. In order to do this, the patent analysis service 110 communicates via a LAN/WAN 112 with the Patent Document Database 104 in order to gather the patent documents 106 needed for the analysis. A document query 114 is generated by the patent analysis service 110 and sent to the patent document database 104. The patent document database performs a search according to the attributes in the document query 114 and produces a document response 116 which includes zero or more patent documents 106. Upon receipt of the document response 116, an analysis can be performed. In some embodiments, the first step in this process is to parse the documents for needed data and persist them in a patent analysis database 118 running on a server or virtual machine/container 120. In other embodiments, the parsed document data needed for an analysis is kept in Random Access Memory (RAM). In preferred embodiments, the independent claims (ICs) of each patent document 106 are determined and parsed.

Once the parsed document data is available, an analysis of the patents in the set is performed by the Patent Analysis Service 110. As detailed in the sections that follow, the types of analysis may include, but are not limited to set analysis, peer discovery, extended set analysis, maintenance fee recommendations and law firm analysis. In some embodiments this results in additional analysis data being persisted in the Patent Analysis Database 118. The Patent Analysis Service 110 also provides an API 124 to enable system access via a PAS GUI 126 or another service.

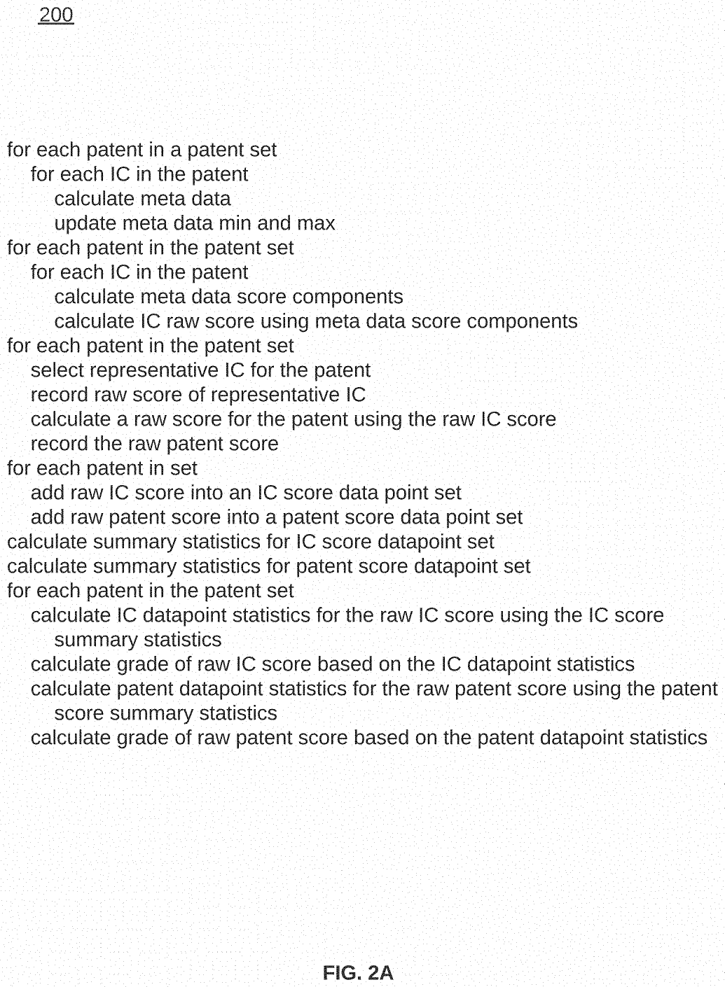

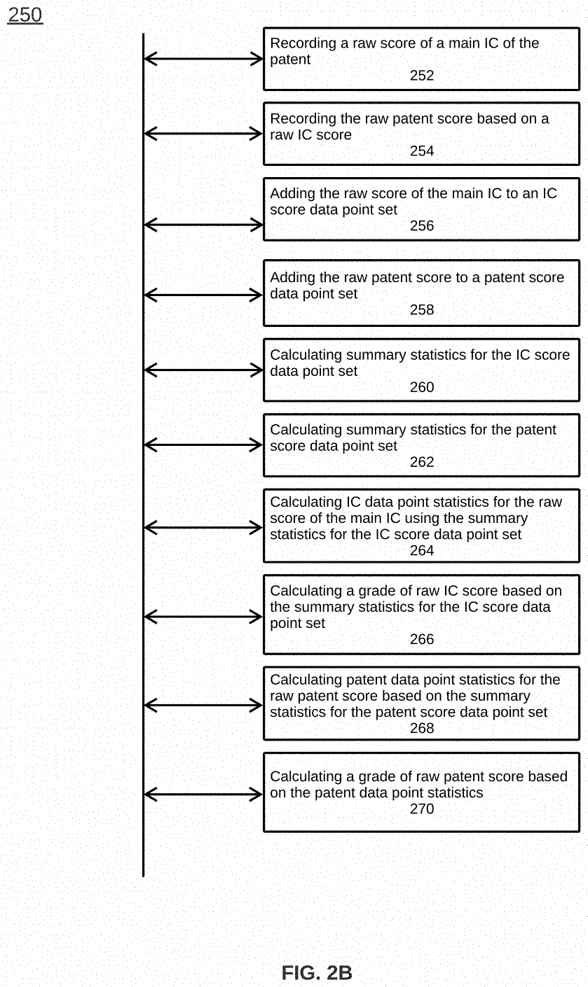

FIG. 2A illustrates a code segment 200 of patent set analysis, according to example embodiments. In accordance with one or more embodiments of the present application, a set of meta data is calculated for each IC in each patent of a patent set. In some embodiments, the meta data calculated about each Independent Claim (IC) includes but is not limited to claim length, elements, details, steps and features. In some embodiments the minimum and maximum values of one or more pieces of claim meta data across a patent set are recorded.

In accordance with one or more embodiments of the present application, a claim meta data value is used to calculate a raw score component of an independent claim. In some embodiments, the raw score component is calculated using a normalization formula. In one embodiment the normalization formula includes the minimum and maximum meta data values. In some embodiments the raw score of the independent claim is calculated by combining one or more raw score components. In some embodiments, the formula for combining the raw score components is configurable. In one embodiment, the raw independent claim score calculation includes a weight for the one or more raw score components.

In accordance with one or more embodiments of the present application, an IC in each patent is selected as representative of the patent. In such embodiments, the raw score of the representative IC is recorded against the patent. In some embodiments, the selection algorithm is configurable. In one embodiment, the selection algorithm options include but are not limited to best, first, worst and median. In other embodiments, a representative claim is not selected, instead an average of the raw scores of one or more independent claims is recorded as the raw IC score against the patent.

In accordance with one or more embodiments of the present application, once a raw IC score is recorded against a patent, a raw patent score is calculated using the raw IC score. In some embodiments, the raw patent score calculation includes other components based on meta data about aspects of the patent. In some embodiments, the other components include but are not limited to citation count, PCT status, independent claim count and total claim count. Once the raw patent score is calculated, it is recorded against the patent.

In accordance with one or more embodiments of the present application, once the raw IC and patent scores have been recorded against each patent in the set, the raw IC scores are added to an IC score datapoint set. Summary statistics are then calculated against the IC datapoint set. In some embodiments, the summary statistics may include but are not limited to minimum value, maximum value, mean, median, variance, and standard deviation.

In accordance with one or more embodiments of the present application, summary statistics are also calculated against the patent score datapoint set. In some embodiments, the summary statistics may include but are not limited to minimum value, maximum value, mean, median, variance and standard deviation.

In accordance with one or more embodiments of the present application, once the summary statistics are calculated for the raw IC scores, the datapoint statistics of the raw IC scores of each patent are calculated. In some embodiments, the datapoint statistics include but are not limited to delta from mean, percentile rank and z-score. In some embodiments, an IC grade is also calculated for each patent. In some embodiments, the grade calculation utilizes one or more datapoint statistics. In one embodiment, the grade reflects the IC score position in a normal distribution of one or more IC scores in the patent set.

In accordance with one or more embodiments of the present application, once the summary statistics are calculated for the raw patent scores, the datapoint statistics of the raw patent scores of each patent are calculated. In some embodiments, the datapoint statistics include but are not limited to delta from mean, percentile rank and z-score. In some embodiments, a patent grade is also calculated for each patent. In some embodiments, the grade calculation utilizes one or more datapoint statistics. In one embodiment, the grade reflects an averageable patent score position in a normal distribution of one or more patent scores in the patent set.

FIG. 2B illustrates a flowchart of patent set analysis, according to example embodiments. Referring to FIG. 2B, the method may comprise one or more of recording a raw score of a main IC of the patent 252, recording the raw patent score based on a raw IC score 254, adding the raw score of the main IC to an IC score data point set 258, adding the raw patent score to a patent score data point set 260, calculating summary statistics for the IC score data point set 260, calculating summary statistics for the patent score data point set 262, calculating IC data point statistics for the raw score of the main IC using the summary statistics for the IC score data point set 264, calculating a grade of raw IC score based on the summary statistics for the IC score data point set 266, calculating patent data point statistics for the raw patent score based on the summary statistics for the patent score data point set 268, and calculating a grade of raw patent score based on the patent data point statistics 270.

illustrates a flowchart of patent set analysis, according to example embodiments.

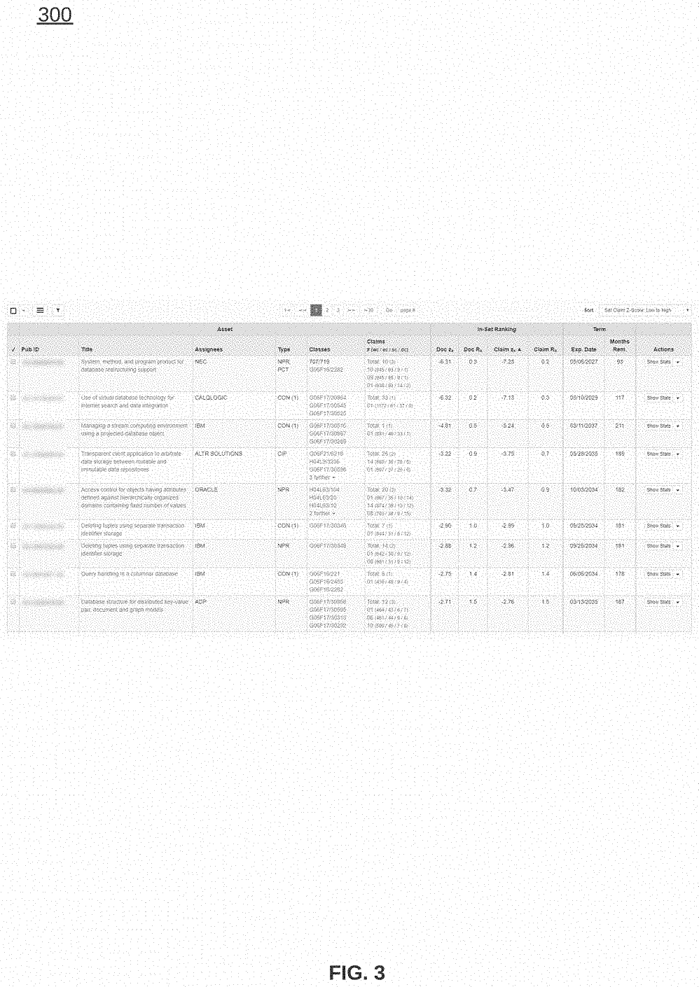

FIG. 3 illustrates a GUI snapshot of patent set analysis, according to example embodiments. The snapshot 300 shows the fields of the analysis including the title, assignees, the type of the patent, the filed classes of the patent, an analysis of the claims, the in-set ranking data, and the term data of the patent of the list of patents.

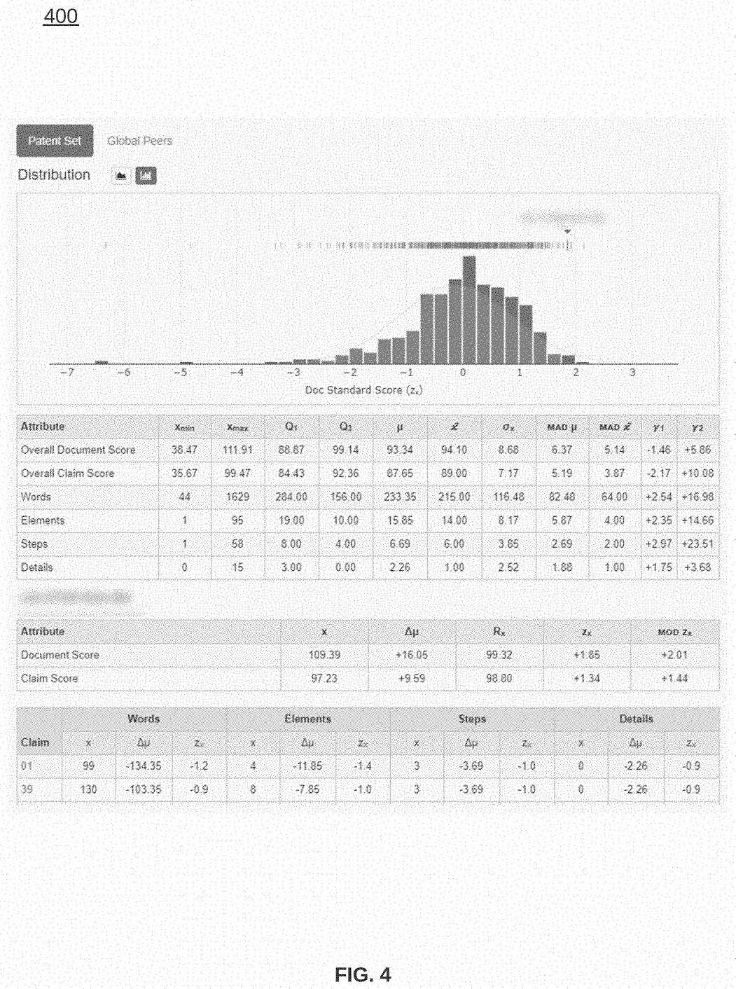

FIG. 4 illustrates another GUI snapshot of patent set analysis, according to example embodiments. The snapshot 400 shows the patent stats view for a given patent set.

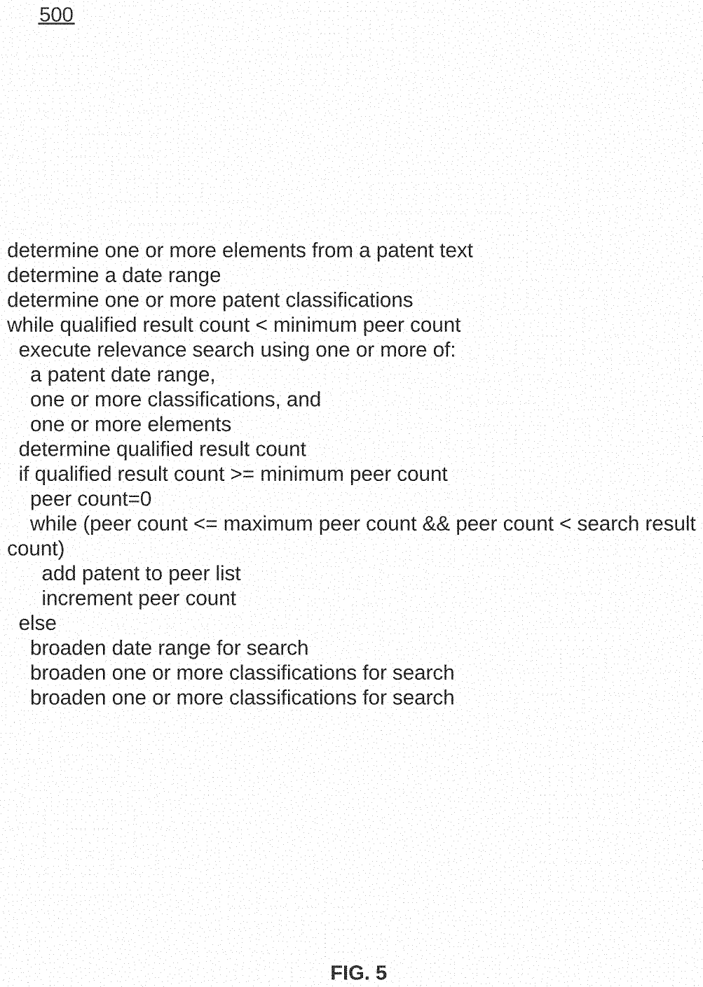

FIG. 5 illustrates a code segment of finding patent peers, according to example embodiments. The code shows the determination of locating the patent peers 500. In accordance with one or more embodiments of the present application one or more elements is determined from a patent text in order to enable a search to find a list of peer patents. In some embodiments, the patent text is a published patent document. In other embodiments, the text is a draft patent application. In some embodiments an element is a noun phrase starting with an indefinite article.

In accordance with one or more embodiments of the present application, an initial date range for a patent search is determined. In some embodiments, the date range includes a priority date of a patent. In other embodiments, the date range includes a publication date of a patent. In some embodiments the span of the date range is configurable.

In accordance with one or more embodiments of the present application, one or more classifications for a patent search are determined. In some embodiment the classification list may include a classification from a published patent. In preferred embodiments, the classifications follow the Cooperative Patent Classification (CPC) system. In one embodiment, the classifications may be expressed as a hierarchical range.

In accordance with one or more embodiments of the present application, a search is executed using the one or more elements as search terms, one or more classifications and a date range. The search returns zero or more search results each of which includes a relevance score and a patent. Once the results have been returned, the results are examined to determine a qualified result count. In some embodiments the qualified result count is determined by taking a configurable percentage of the total result count. In other embodiments the qualified result count is based on a statistical analysis of the relevance score of each result.

In accordance with one or more embodiments of the present application, if the qualified result count is greater than or equal to a minimum peer count, then the results are added into a peer list until a maximum peer count is reached In some embodiments, the minimum peer count is configurable. In some embodiments, the maximum peer count is configurable. If the qualified result count is less than the minimum peer count, then the search is broadened. In some embodiments, the search is broadened by expanding the patent date range. In some embodiments the search is broadened by replacing the one or more classifications with one or more higher level classifications. The search process is repeated until the qualified result count is greater than or equal to the minimum result count.

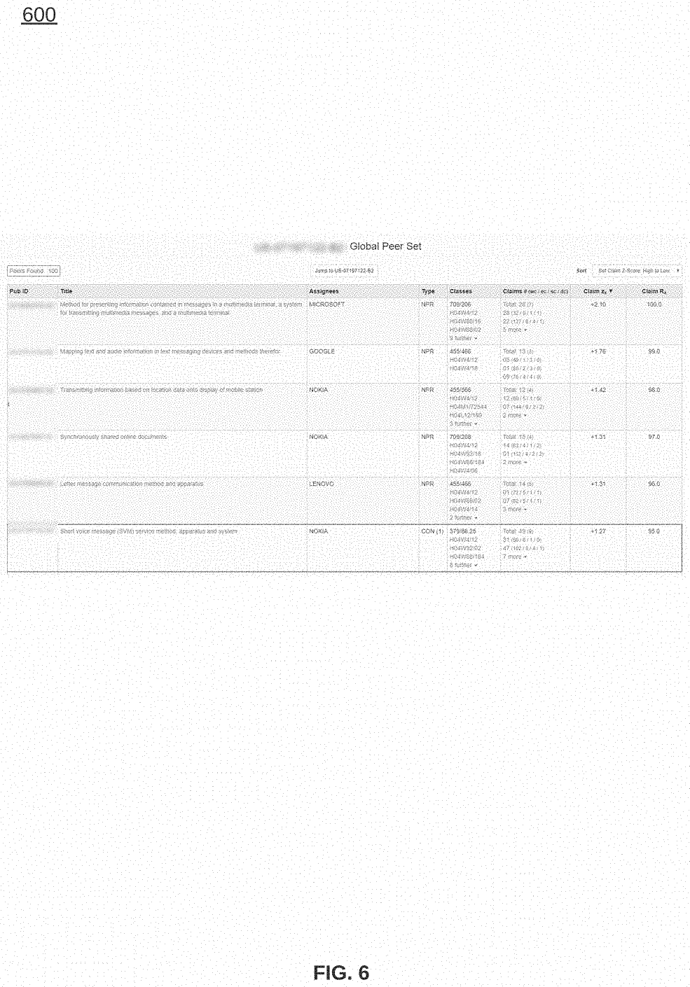

FIG. 6 illustrates a GUI snapshot of finding patent peers, according to example embodiments. The snapshot 600 shows a peer list view wherein a patent's peers are ranked and the subject patent (or application) claim is ranked alongside its peers.

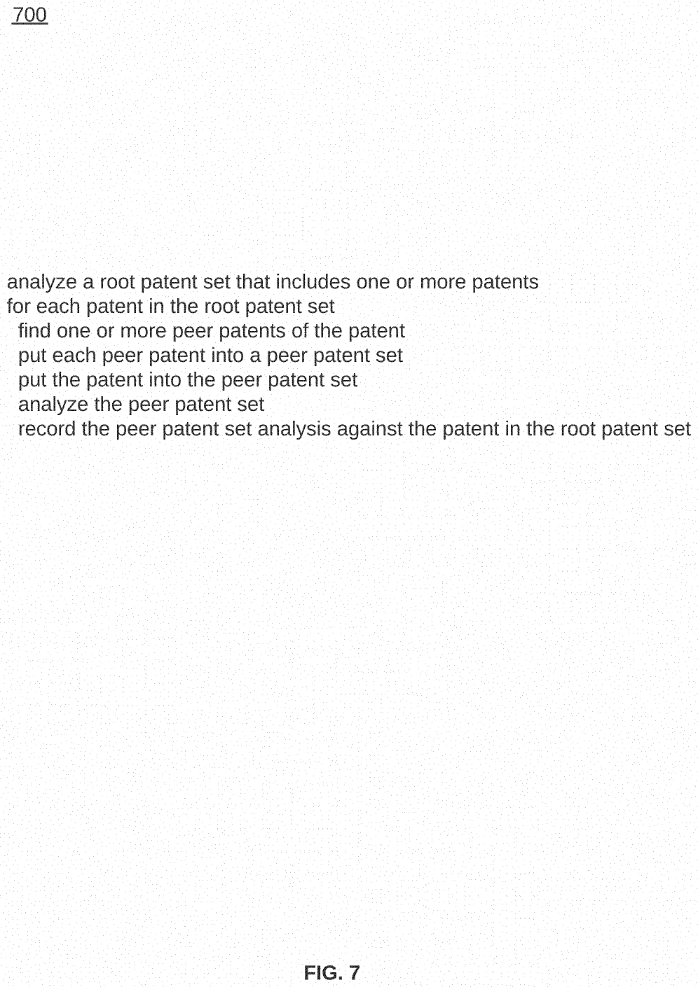

FIG. 7 illustrates a code segment of extended patent set analysis, according to example embodiments. The code segment 700 shows the instant logic to determine an extended patent set. In accordance with one or more embodiments of the present application a root patent set that includes one or more patents is analyzed. In preferred embodiments each patent in the root patent set is analyzed with respect to other patents in the root patent set. In some embodiments the patent set analysis generates a score for each patent in the root patent set. In some embodiments the patent set analysis generates a grade for each patent in the root patent set. In some embodiments the patent set analysis calculates one or more statistics about each patent. In some embodiments, the analysis follows the method described in section Patent Set Analysis.

In accordance with one or more embodiments of the present application, one or more peer patents are found for each patent in the root patent set. In some embodiments one or more classifications of the patent are used to located peers. In some embodiments a date range is used to locate peers. In some embodiments one or more terms in the patent text are used to locate peers. In preferred embodiments, the method described in section Finding Patent Peers is utilized to find the peer patents. Once found, each peer patent is added into a peer patent set. Additionally, the patent in the portfolio set is put into the peer patent set. Once constructed, the peer patent set is analyzed. In some embodiments, the peer patent set analysis follows the method described in section Patent Set Analysis. After the peer set analysis is complete, a peer set analysis result is recorded against the patent in the portfolio patent set. In some embodiments, the peer set analysis includes a peer set score of the patent. In some embodiments, the peer set analysis includes a peer set grade of the patent. In some embodiments, the peer set analysis calculates one or more statistics about the patent. This peer set analysis process repeats for all patents in the root patent set. In some embodiments, the peer analysis of the one or more patents in the root set are executed concurrently.

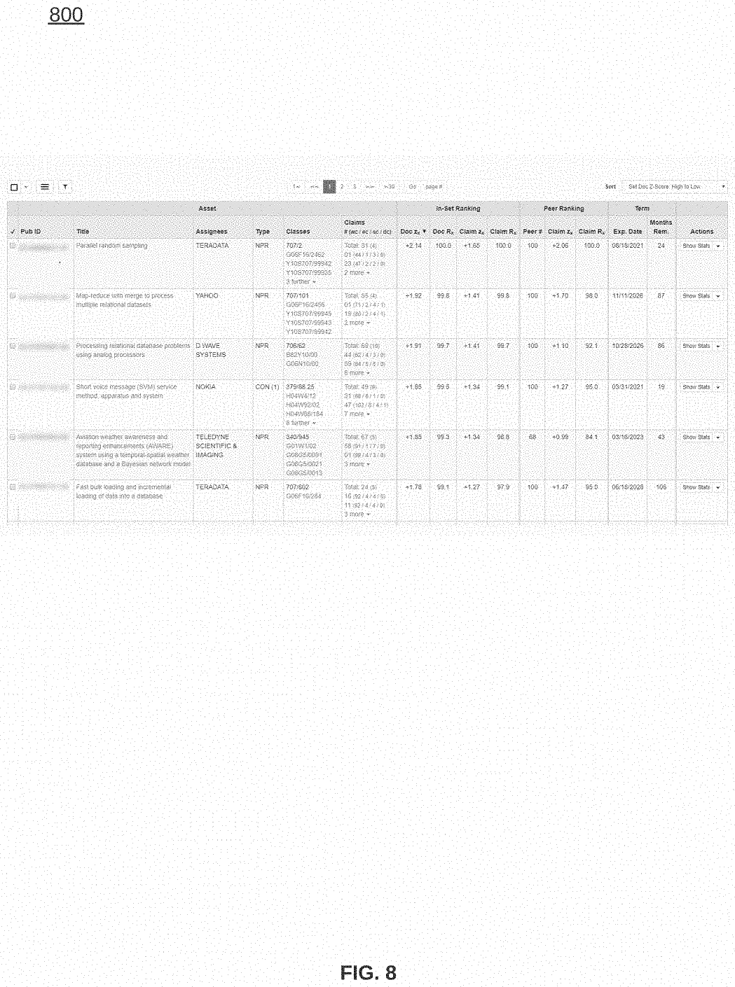

FIG. 8 illustrates a GUI snapshot of extended patent set analysis, according to example embodiments. The snapshot 800 shows the patent set plus the patent's peers view.

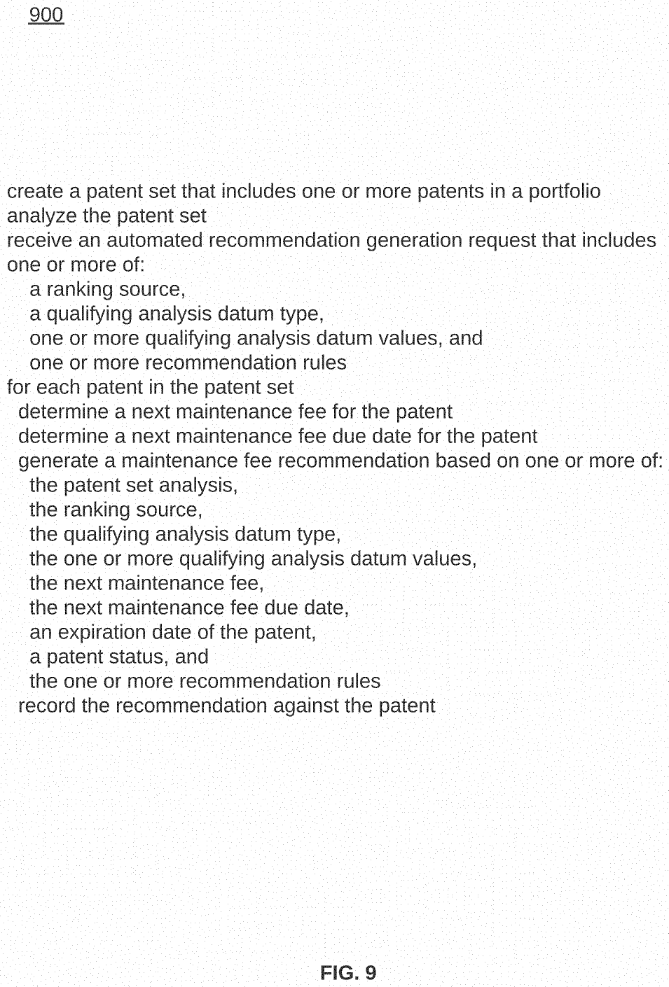

FIG. 9 illustrates a code segment of automated maintenance fee recommendations, according to example embodiments. The instant logic shows the determination of calculating the maintenance fee recommendations. In accordance with one or more embodiments of the present application a patent set is created that include one or more patents. In some embodiments, the patent set is created from a set of patent search results. In some embodiments, the one or more patents are from the portfolio of a particular entity.

In accordance with one or more embodiments of the present application the patent set is analyzed. In preferred embodiments each patent in the portfolio patent set is analyzed with respect to other patents in the portfolio patent set. In some embodiments, the analysis follows the method described in section Patent Set Analysis. In some embodiments, the patents in the patent set are analyzed with respect to a set of peer patents which may or may not be part of the patent set. In some embodiments, the analysis follows the method described in section Extended Patent Set Analysis.

In accordance with one or more embodiments of the present application an automated recommendation generation request is received. In some recommendations, the request includes a ranking source. In some embodiments the ranking source is one of the original set or a peer set. In some embodiments, the request includes a qualifying analysis datum type. In some embodiments the qualifying analysis datum type options include but is not limited to, patent z-score, patent grade or patent set percentage. In some embodiments, the request includes one or more qualifying analysis datum type values. In some embodiments the qualifying analysis datum type value may reflect a patent z-score, a patent grade or patent set percentage. In some embodiments, the request includes one or more recommendation rules. In some embodiments the recommendation rules include but are not limited to abandon limits per fee and a human recommendation override option.

In accordance with one or more embodiments of the present application, each patent in the patent set is analyzed to determine an appropriate recommendation. If a next maintenance fee is due, a next maintenance fee due date is also determined. In accordance with one or more embodiments of the present application, a maintenance fee recommendation for the patent is then generated. In some embodiments, the maintenance fee recommendation is driven by analysis data identified by the ranking source. In some embodiments, the maintenance fee recommendation is driven by analysis data identified by the qualifying analysis datum type. In some embodiments the maintenance fee recommendation is driven by the one or more qualifying analysis datum values. For example, a recommendation may be driven by the patent grade of a patent in a peer patent set analysis being less than a qualifying datum value. Alternatively, it may be driven by the z-score of best IC in the patent in a root patent set analysis. In some embodiments, the maintenance fee recommendation is influenced by a patent grade generated during the analysis of the patent set. In further embodiments, the maintenance fee recommendation is influenced by a patent statistic generated during the analysis of the patent set. In these embodiments, the patent statistic may include, but is not limited to a z-score or a percentile rank.

In accordance with one or more embodiments of the present application, the maintenance fee recommendation is influenced by the next maintenance fee due. In further embodiments, the maintenance fee recommendation is influenced by the next maintenance fee due date. In some embodiments, the maintenance fee recommendation is influenced by an expiration date of the patent. In further embodiments, the maintenance fee recommendation is influenced by a patent status. In such embodiments, the patent status may include but is not limited to active and expired.

In accordance with one or more embodiments of the present application, the maintenance fee recommendation is influenced by the one or more recommendation rules. In some embodiments, a recommendation rule may prohibit an abandon recommendation for a patent based on the next fee due.

In accordance with one or more embodiments of the present application, a human reviewer may also create or update a maintenance fee recommendation. In some embodiments, a recommendation rule may enable overriding a human reviewer's existing recommendation.

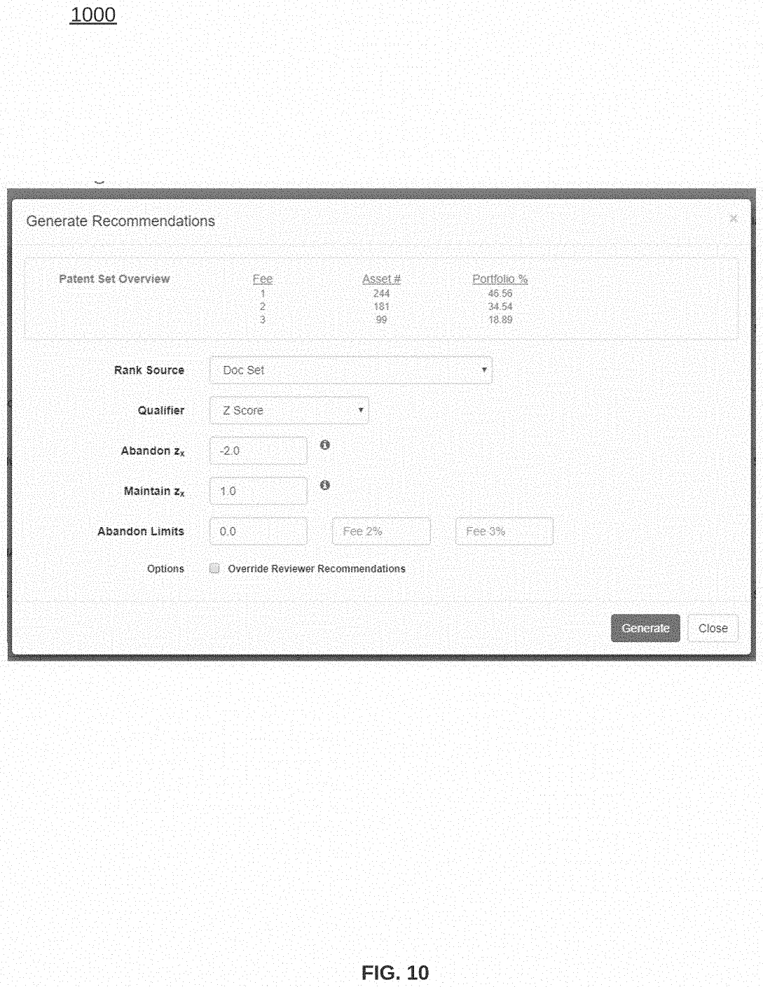

FIG. 10 illustrates a GUI snapshot of automated maintenance fee recommendations, according to example embodiments. The snapshot 1000 depicts a GUI utilized to generate a recommendation request.

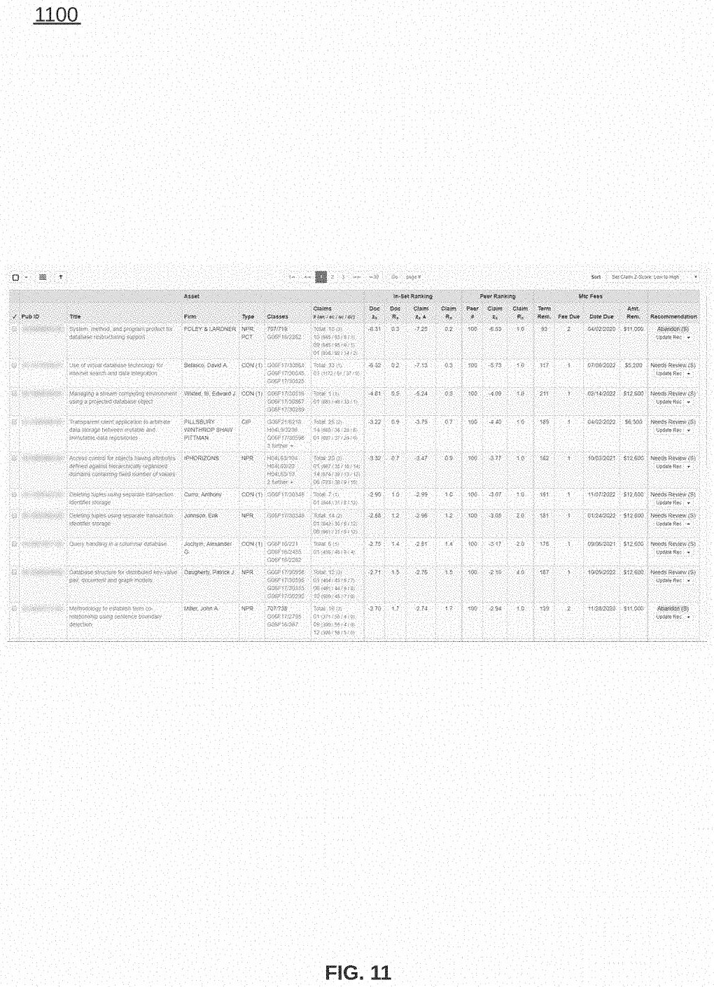

FIG. 11 illustrates another GUI snapshot of automated maintenance fee recommendations, according to example embodiments. The snapshot 1100 depicts a table of a patent set recommendation view.

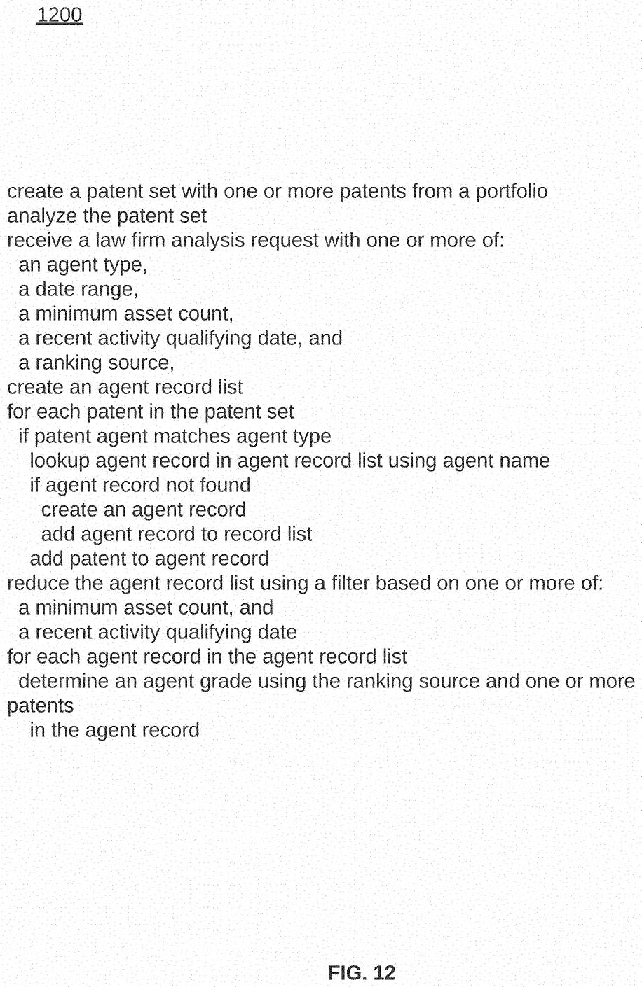

FIG. 12 illustrates a code segment of law firm analysis, according to example embodiments. The code segment 1200 depicts the instant logic used to calculate the law firm analysis. In accordance with one or more embodiments of the present application a patent set is created that include one or more patents. In some embodiments, the patent set is created from a set of patent search results. In some embodiments, the one or more patents are from the portfolio of a particular entity.

In accordance with one or more embodiments of the present application the patent set is analyzed. In preferred embodiments each patent in the portfolio patent set is analyzed with respect to other patents in the portfolio patent set. In some embodiments, the analysis follows the method described in section Patent Set Analysis. In some embodiments, the patents in the patent set are analyzed with respect to a set of peer patents which may or may not be part of the patent set. In some embodiments, the analysis follows the method described in section Extended Patent Set Analysis.

In accordance with one or more embodiments of the present application a law firm analysis request is received. In some embodiments, the request includes an agent type. In such embodiments the agent type options include are not limited to individual agent, firm or both. In some embodiments the request includes a patent date range to limit the assets considered when performing the analysis. In some embodiments, the request includes a minimum asset count that enables filtering out agents with insufficient associated assets. In some embodiments, the request includes a recent activity qualification date in order to exclude agents which have not handled any recent patents. In some embodiments, the request may include a ranking source. In some embodiments the ranking source is one of the original patent set or a peer set.

In accordance with one or more embodiments of the present application once the law firm analysis request is received an agent record list is created. At this point, each patent in the patent set is examined. If the agent associated with the patent matches the agent type filter, then an attempt is made to locate an agent record for the agent in the agent record list using an agent id. If the agent record is not found, then an agent record is created with an id of the agent. The agent record is then added to the agent record list. If the agent record is found or if it was created, the patent is added to the agent record. This process repeats for all patents in the patent set.

In accordance with one or more embodiments of the present application, once the agent record list has been populated, the list is then reduced based on a filter that includes one or more of the minimum asset count and the recent activity qualifying date. At this point a grade is determined for each agent record in the agent record list. In some embodiments, the grade is determined by examining one or more analysis datum identified by the ranking source in one or more patents in the agent record. In some embodiments, the grade is the mean of the grades of the one or more patents in the agent record. In some embodiments, the grade is the median of the grades of the one or more patents in the agent record. In some embodiments further statistics are determined from the grade of the one or more patents in the agent record. In some embodiments, the further statistics include a minimum value, a maximum value and a standard deviation.

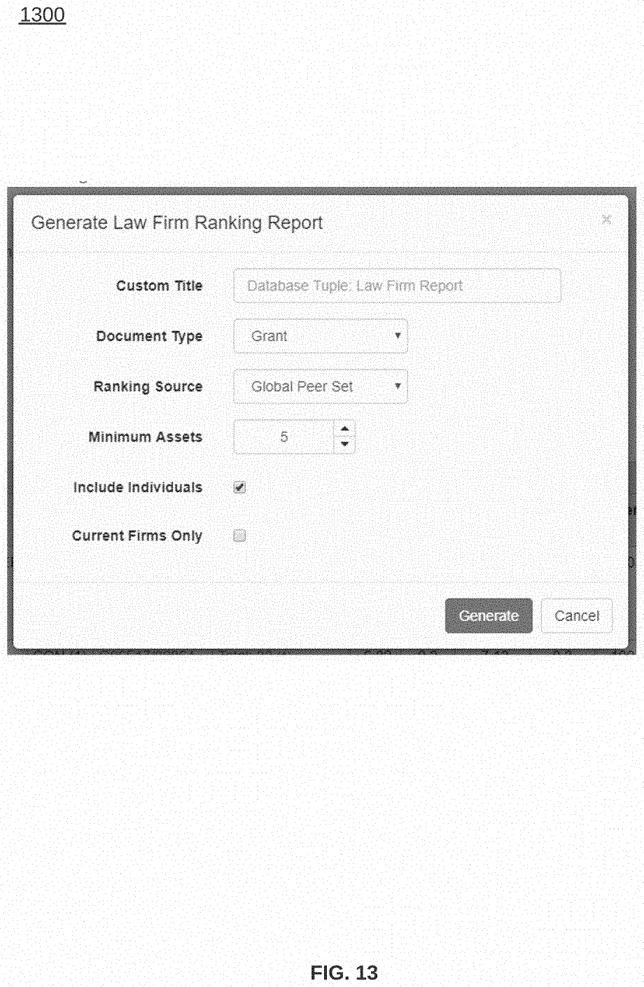

FIG. 13 illustrates a GUI snapshot of law firm analysis, according to example embodiments. The snapshot 1300 shows a law firm analysis request GUI.

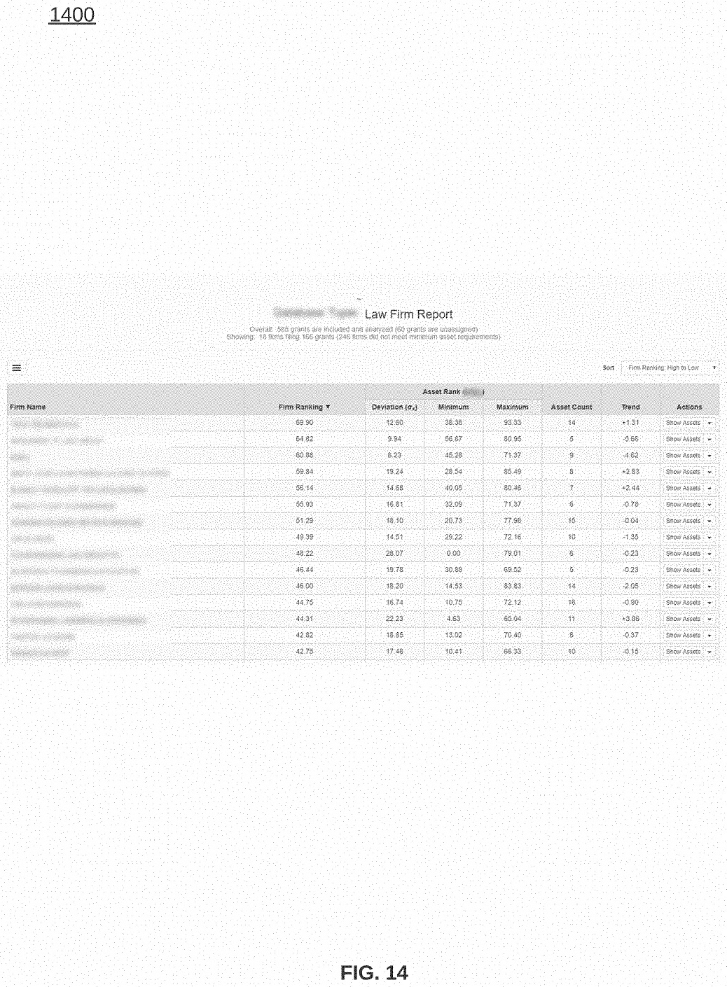

FIG. 14 illustrates another GUI snapshot of law firm analysis, according to example embodiments. The snapshot 1400 shows an example table of a law firm analysis report.

What is claimed is:

1. A method, comprising:
adding a raw score of a main independent claim (IC) of a patent to an IC score data point set;
adding the raw patent score to a patent score data point set;
calculating summary statistics for the IC score data point set and the patent score data point set;
calculating IC data point statistics for the raw score of the main IC and grade of raw IC score based on the summary statistics for the IC score data point set;
calculating patent data point statistics for the raw patent score based on the summary statistics for the patent score data point set;
calculating a grade of raw patent score based on the patent data point statistics; and
displaying the grade of the raw patent score.

2. The method of claim 1, comprising updating the metadata min and the metadata max.

3. The method of claim 1, wherein the metadata is calculated for each IC in the patent.

4. The method of claim 1, wherein the raw IC score is calculated using scored components of metadata for each IC in the patent.

5. The method of claim 1, comprising calculating the data point statistics of the raw patent score after calculating the summary statistics for the raw patent score.

6. The method of claim 1, comprising calculating the data point statistics of the raw IC score after calculating the summary statistics for the raw IC score.

7. The method of claim 1, comprising calculating summary statistics against the patent score data point set.

8. A system, comprising:
a processor and memory communicably coupled to the processor, wherein the processor is configured to perform:
add a raw score of a main independent claim (IC) of a patent to an IC score data point set;
add the raw patent score to a patent score data point set;
calculate summary statistics for the IC score data point set and the patent score data point set;
calculate IC data point statistics for the raw score of the main IC and grade of raw IC score based on the summary statistics for the IC score data point set;
calculate patent data point statistics for the raw patent score based on the summary statistics for the patent score data point set;
calculate a grade of raw patent score based on the patent data point statistics; and
display the grade of the raw patent score.

9. The system of claim 8, comprising update the metadata min and the metadata max.

10. The system of claim 8, wherein the metadata is calculated for each IC in the patent.

11. The system of claim 8, wherein the raw IC score is calculated by the use of scored components of metadata for each IC in the patent.

12. The system of claim 8, comprising calculate the data point statistics of the raw patent score after the calculation of the summary statistics for the raw patent score.

13. The system of claim 8, comprising calculate the data point statistics of the raw IC score after the calculation of the summary statistics for the raw IC score.

14. The system of claim 8, comprising calculate summary statistics against the patent score data point set.

15. A non-transitory computer readable medium comprising instructions, that when read by a processor, cause the processor to perform:
adding a raw score of a main independent claim (IC) of a patent to an IC score data point set;
adding the raw patent score to a patent score data point set;
calculating summary statistics for the IC score data point set and the patent score data point set;
calculating IC data point statistics for the raw score of the main IC and grade of raw IC score based on the summary statistics for the IC score data point set;
calculating patent data point statistics for the raw patent score based on the summary statistics for the patent score data point set;
calculating a grade of raw patent score based on the patent data point statistics; and
displaying the grade of the raw patent score.

16. The non-transitory computer readable medium of claim 15, wherein the metadata is calculated for each IC in the patent.

17. The non-transitory computer readable medium of claim 15, wherein the raw IC score is calculated using scored components of metadata for each IC in the patent;

18. The non-transitory computer readable medium of claim 15, comprising calculating the data point statistics of the raw patent score after calculating the summary statistics for the raw patent score.

19. The non-transitory computer readable medium of claim 15, comprising calculating the data point statistics of the raw IC score after calculating the summary statistics for the raw IC score.

20. The non-transitory computer readable medium of claim 15, comprising calculating summary statistics against the patent score data point set.
